(19) United States
(12) Patent Application Publication
(10) Pub. No.: US 2022/0414387 A1
(43) Pub. Date: Dec. 29, 2022

(54) ENHANCED OBJECT DETECTION SYSTEM BASED ON HEIGHT MAP DATA

(71) Applicant: GM Cruise Holdings LLC, San Francisco, CA (US)

(72) Inventors: Hariprasad Govardhanam, Fremont, CA (US); Bryce A. Evans, San Mateo, CA (US)

(21) Appl. No.: 17/355,405

(22) Filed: Jun. 23, 2021

(51) Int. Cl. G06K 9/00; G05D 1/02; G01S 17/894; G01S 17/931; G01S 17/86

(52) U.S. Cl. CPC G06K 9/00805; G05D 1/0248; G01S 17/894; G01S 17/931; G01S 17/86; G05D 2201/0213

(57) ABSTRACT

The disclosed technology provides solutions for improving object detection system based on height map data. A process of the disclosed technology can include steps for receiving image data, receiving height map data, the height map data corresponding with a location of the image data, projecting the height map data onto the image data to generate composite image data, and training an object detection model based on the composite image data. In some aspects, the process can further include steps for localizing one or more objects represented by the image data using the object detection model. Systems and machine-readable media are also provided.

### BACKGROUND

### 1. Technical Field

The subject technology relates to solutions for improving an object detection system and in particular, for improving an object detection system by utilizing height map data.

### 2. Introduction

Object detection systems require accurate detection, classification, and localization of an object. Based on various detection technologies (e.g., cameras, radar, light detection and ranging (LiDAR) sensors, or ultrasound), the object detection systems can detect and identify art object(s) in the surrounding environment. However, due to the difficulty of estimating distance or the high cost of implementing a sensor that provides accurate distance data, conventional object detection systems have a limited ability in accurately localizing an object(s).

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates a block diagram of an example object detection system utilizing height map data, according to some aspects of the disclosed technology.

FIG. 2 illustrates an example of projecting height map data onto image data, according to some aspects of the disclosed technology.

FIG. 3 illustrates a block diagram of art example system including a neural network, according to some aspects of the disclosed technology.

FIG. 4 illustrates a block diagram of a process for improving an object detection system, according to some aspects of the disclosed technology.

FIG. 5 illustrates an example system environment that can be used to facilitate AV dispatch and operations, according to some aspects of the disclosed technology.

FIG. 6 illustrates art example processor-based system with which some aspects of the subject technology cart be implemented.

### DETAILED DESCRIPTION

The detailed description set forth below is intended as a description of various configurations of the subject technology but is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Object detection systems can perform object detection using a variety of sensor data sources, such as cameras, radar, and LiDAR sensors that perform in different ways and with various limitations with respect to localization and classification of objects. For example, when using only camera image data, a classifier/localization system performs with a limited ability in accurately localizing objects since camera image data fail to provide depth information. Also, the object classification and localization accuracy is limited when using only LiDAR data as the classifier/localization system cannot accurately classify objects.

Aspects of the disclosed technology address the foregoing limitations of conventional object detection systems, by providing systems, methods, and machine-readable media that provide solutions for improving object detection by utilizing height map data. More specifically, object detection and localization accuracy can be enhanced by utilizing composite image data that includes height map information. As discussed in further detail below, the disclosed technology includes a process for projecting height map data onto image data where the height map data corresponds with a location of the image data to generate composite image data. Additionally, the object detection system can include a three dimensional object detection model (e.g., machine learning neural network) that has been trained using the composite image data generated by projecting the height map data onto the image data.

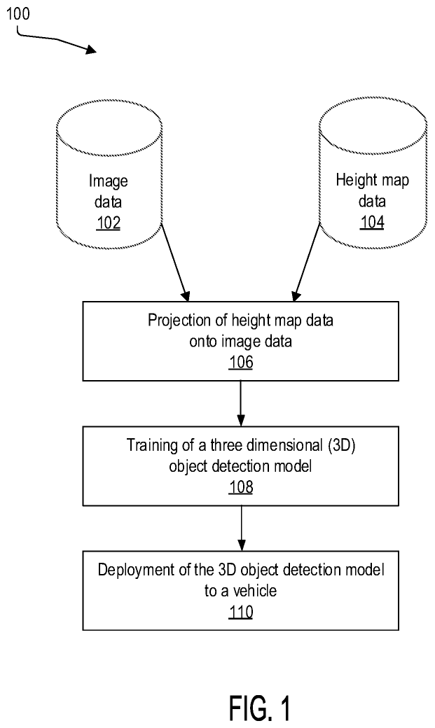

FIG. 1 illustrates a conceptual block diagram of art example object detection system 100 based on image data 102 and height map data 104, according to some aspects of the disclosed technology. The object detection system 100 cart be implemented in various systems such as, but not limited to, autonomous vehicles, automobiles, motorcycles, trains, and aircraft. For exemplary purposes, the present disclosure is discussed in the context of the object detection system implemented in a vehicle.

In the example of FIG. 1, object detection system 100 can be configured to receive image data 102 and height map data 104. Image data 102 can be obtained from a vehicle mounted camera.

In some instances, height map data 104 can comprise high resolution map data with depth information, e.g., three dimensional position information. Height map data 104 can also comprise distance data indicating a height and a location or three dimensional mapping information. In some aspects, height map data 104 can include a priori information collected by a vehicle or readily accessible by the vehicle. Also, height map data 104 can be collected by arty applicable sensors such as a LiDAR sensor or Time of Flight (ToF) camera. In some aspects, object detection system 100 can receive height map data 104 from any applicable database (e.g., LiDAR database), which can be located within the vehicle or outside of the vehicle.

Furthermore, height map data 104 can correspond with a location of image data 102. For example, a location represented by image data 102 can be the location represented by height map data 104.

In some examples, object detection system 100 can overlay height map data 104 onto image data 102 to generate composite image data (block 106). Image data 102 and height map data 104 can be aligned such that coordinates of the location in image data 102 match coordinates of the location in height map data 104. For example, projecting height map data 104 onto image data 102 can include identification of various image objects in image data 102 and height map data 104 and aligning pixel regions corresponding with various image objects. Further details regarding the alignment of camera image data and LiDAR data is provided by U.S. application Ser. No. 16/814,639, entitled, “IMAGE AND LIDAR SEGMENTATION FOR LIDAR-CAMERA CALIBRATION,” which is incorporated by reference in its entirety.

In some approaches, object detection system 100 can include a 3D object detection model that has been trained using the composite image data (block 108). For example, object detection system 100 can train a neural network based on the composite image data comprising depth information and improve the localization of an object.

In some aspects, object detection system 100 can deploy the 3D object detection model to a vehicle (block 110). The 3D object detection model based on the composite image data can significantly enhance the object detection system of the vehicle by providing an improved localization of art object.

In some instances, image data 102 can include Inertial Measurement Unit (IMU) data. For example, an IMU, which can be located within a vehicle or outside of the vehicle, measures a tilt with respect to a roadway when the vehicle may experience tilt, for example, when the vehicle hits a brake or drives over a bump. In some aspects, the IMU data can also be used for adjustment of a height and location to compensate for the tilt.

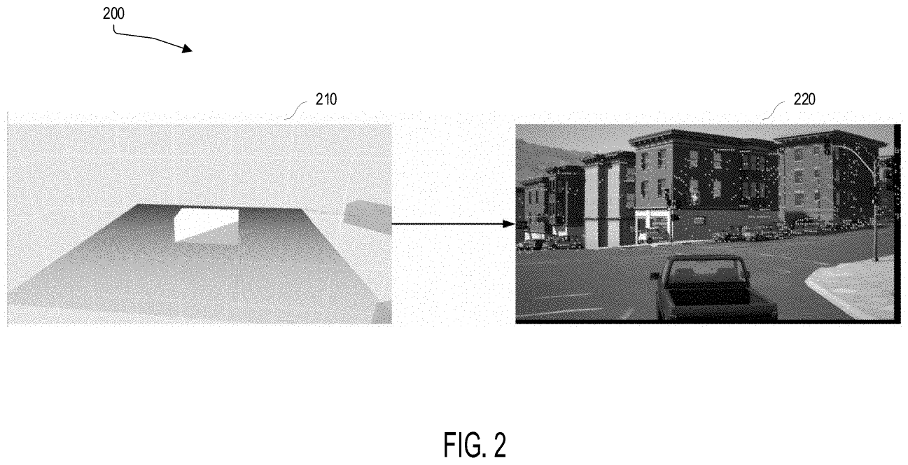

FIG. 2 illustrates an example process 200 of projecting height map data 210 onto image data 220, according to some aspects of the disclosed technology. In the example of FIG. 2, the example height map data 210 shows a height map around a vehicle. Height map data 210 includes depth information of the location represented by height map data 210.

The example image data 220 comprising various image objects in a RGB color space can be overlaid with height map data 210 by using depth points as shown in FIG. 2. A composite image data comprises various image objects including a RGB color space and depth information. In some examples, accurate composite image data can be generated by aligning pixel regions corresponding with various image objects in image data and height map data.

In some aspects, image noise such as random variation of brightness or color information in image data can be filtered out to better align height map data onto image data and generate an accurate composite image data.

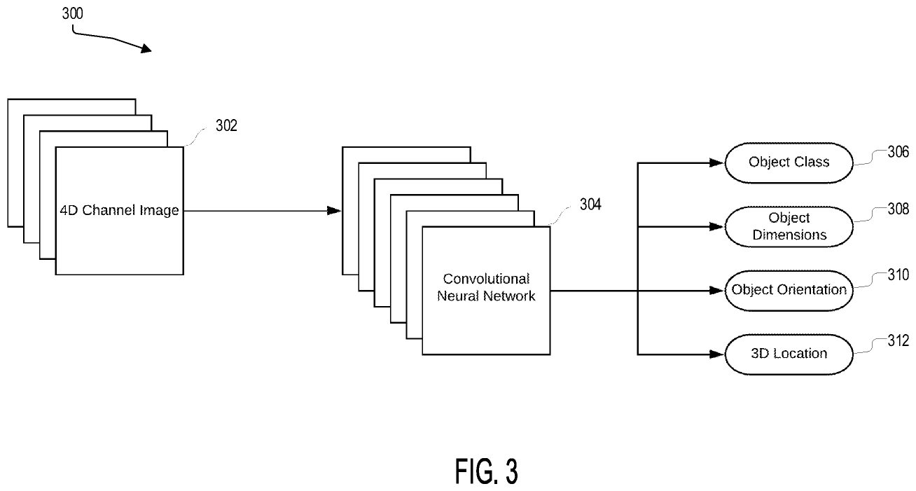

FIG. 3 illustrates a block diagram of an example system 300 including neural network 304 based on composite image data 302, according to some aspects of the disclosed technology. System 300 includes a repository of composite image data 302 (e.g., 4D channel images comprising both color channels and depth channels) from which images are provided to convolutional neural network 302. Composite image data 302 can comprise various image objects including a combination of a RGB color space and depth information.

In some examples, neural network 302 can be configured to receive composite image data 302 and identify image objects therein. For example, composite image data 302 can include four channel image data comprising pre-pixel RGB color values from image data and depth values from height map data. Also, identification of image objects can include the identification of pixel regions corresponding with various image objects.

In some aspects, neural network 302 can predict the localization of the various image objects based on the composite image data and output object class 306, object dimensions 308, object orientation 310, or a 3D location 312. For example, an output of neural network 302 can be 3D bounding box including dimensions, centroid position, orientation, and a class. In some examples, the ultimate output can be represented in a 3D bounding box oriented in a 3D space related to a vehicle.

In some instances, in addition to object class 306, object dimensions 308, object orientation 310, or a 3D location 312, one or more auxiliary tasks can be included in the output of the neural network 302.

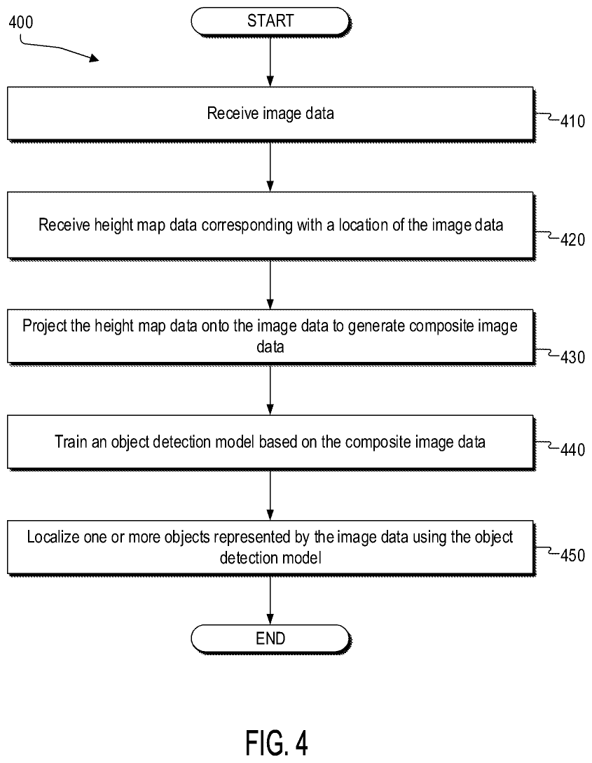

FIG. 4 illustrates a block diagram of a process 400 for improving an object detection system, according to some aspects of the disclosed technology. Process 400 begins with step 410, in which image data (e.g., image data 102) is received, for example, at an object detection system such as object detection system 100 as described in FIG. 1. As discussed above, the image data can include various image objects in a RGB color space. In some examples, the image data can be obtained from a vehicle mounted camera.

At step 420, the object detection system (e.g., object detection system 100 in FIG. 1) can receive height map data (e.g., height map data 104) corresponding with a location of the image data (e.g., image data 102). In some aspects, the height map data can be collected by any applicable sensors such as LiDAR sensor Time of Flight (ToF) camera located within or outside of a vehicle. In some examples, the height map data can also include depth information (e.g., distance information) or various image objects in the location represented by the height map data. Furthermore, the height map data can comprise LiDAR imaging data.

At step 430, the object detection system (e.g., object detection system 100) can project the height map data onto the image data to generate composite image data. For example, the height map data can be overlaid onto the image data by aligning and matching the coordinates and pixel regions corresponding with various image objects in the image data and the height map data. The composite image data generated by the projection of the height map data onto the image data can include not only RGB values from image data but also depth information such as distance data from height map data.

At step 440, the object detection system (e.g., object detection system 100) can train an object detection model based on the composite image data. In some examples, the object detection model is a machine learning neural network. Compared to a conventional object detection system that only provides RGB values from the image data, the object detection model of the disclosed technology can provide depth information from height map data as the height map data is projected onto the image data. As a result, the neural network can learn from depth channels as well as color channels.

At step 450, the object detection system can further identify and localize one or more objects represented by the image data using the object detection model. For example, object detection system can identify objects in image data based on the aligned height map data.

Additionally, the neural network can identify and localize art object(s) in the image data, but not included in the height map data by computing distance from other objects identified both in the image data and the height map data based on the distance information of the height map data.

In some aspects, the object detection system (e.g., object detection system 100 in FIG. 1) can further receive IMU data corresponding with the image data. Also, training the object detection model based on the composite image data can further comprise the IMU data. Such IMU data can help correcting art inaccurate localization by compensating a tilt or vibration that may be experienced by a vehicle.

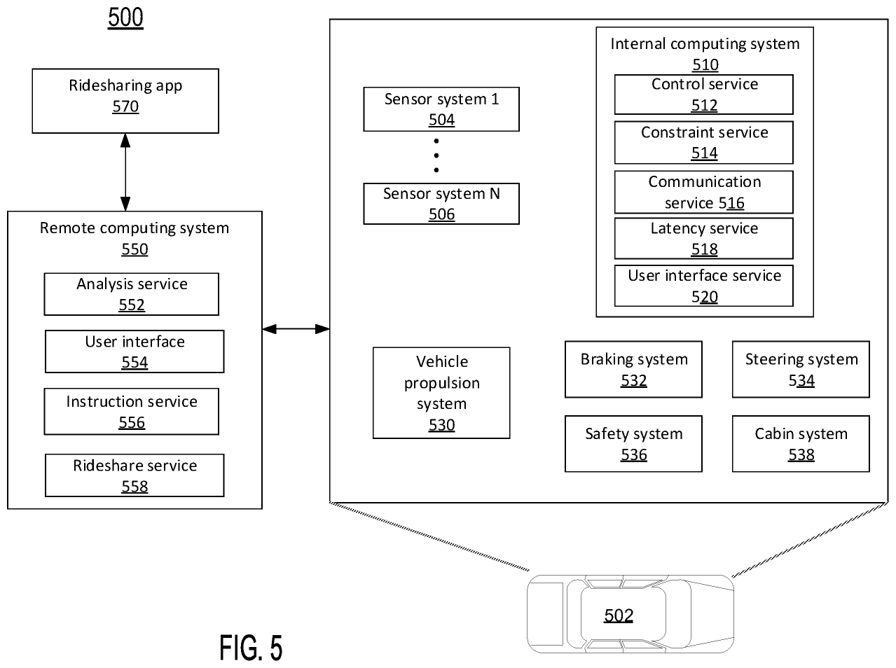

Turning now to FIG. 5 illustrates an example of an AV management system 500. One of ordinary skill in the art will understand that, for the AV management system 500 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 500 includes art AV 502, a data center 550, and a client computing device 570. The AV 502, the data center 550, and the client computing device 570 cart communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 502 can navigate about roadways without a human driver based on sensor signals generated by multiple sensor systems 504, 506, and 508. The sensor systems 504-508 can include different types of sensors and can be arranged about the AV 502. For instance, the sensor systems 504-508 cart comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 504 can be a camera system, the sensor system 506 can be a LIDAR system, and the sensor system 508 can be a RADAR system. Other embodiments may include any other number and type of sensors.

AV 502 cart also include several mechanical systems that cart be used to maneuver or operate AV 502. For instance, the mechanical systems can include vehicle propulsion system 530, braking system 532, steering system 534, safety system 536, and cabin system 538, among other systems. Vehicle propulsion system 530 can include art electric motor, art internal combustion engine, or both. The braking system 532 can include an engine brake, brake pads, actuators, and/or any other suitable componentry configured to assist in decelerating AV 502. The steering system 534 can include suitable componentry configured to control the direction of movement of the AV 502 during navigation. Safety system 536 cart include lights and signal indicators, a parking brake, airbags, and so forth. The cabin system 538 can include cabin temperature control systems, in-cabin entertainment systems, and so forth. In some embodiments, the AV 502 may not include human driver actuators (e.g., steering wheel, handbrake, foot brake pedal, foot accelerator pedal, turn signal lever, window wipers, etc.) for controlling the AV 502. Instead, the cabin system 538 cart include one or more client interfaces (e.g., Graphical User Interfaces (GUIs), Voice User Interfaces (VUIs), etc.) for controlling certain aspects of the mechanical systems 530-538.

AV 502 cart additionally include a local computing device 510 that is in communication with the sensor systems 504-508, the mechanical systems 530-538, the data center 550, and the client computing device 570, among other systems. The local computing device 510 can include one or more processors and memory, including instructions that cart be executed by the one or more processors. The instructions can make up one or more software stacks or components responsible for controlling the AV 502; communicating with the data center 550, the client computing device 570, and other systems; receiving inputs from riders, passengers, and other entities within the AV's environment; logging metrics collected by the sensor systems 504-508; and so forth. In this example, the local computing device 510 includes a perception stack 512, a mapping and localization stack 514, a planning stack 516, a control stack 518, a communications stack 520, an HD geospatial database 522, and an AV operational database 524, among other stacks and systems.

Perception stack 512 can enable the AV 502 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 504-508, the mapping and localization stack 514, the HD geospatial database 522, other components of the AV, and other data sources (e.g., the data center 550, the client computing device 570, third-party data sources, etc.). The perception stack 512 can detect and classify objects and determine their current and predicted locations, speeds, directions, and the like. In addition, the perception stack 512 can determine the free space around the AV 502 (e.g., to maintain a safe distance from other objects, change lanes, park the AV, etc.). The perception stack 512 can also identify environmental uncertainties, such as where to look for moving objects, flag areas that may be obscured or blocked from view, and so forth.

Mapping and localization stack 514 can determine the AV's position and orientation (pose) using different methods from multiple systems (e.g., GPS, IMUs, cameras, LIDAR, RADAR, ultrasonic sensors, the HD geospatial database 522, etc.). For example, in some embodiments, the AV 502 can compare sensor data captured in real-time by the sensor systems 504-508 to data in the HD geospatial database 522 to determine its precise (e.g., accurate to the order of a few centimeters or less) position and orientation. The AV 502 can focus its search based on sensor data from one or more first sensor systems (e.g., GPS) by matching sensor data from one or more second sensor systems (e.g., LIDAR). If the mapping and localization information from one system is unavailable, the AV 502 can use mapping and localization information from a redundant system and/or from remote data sources.

The planning stack 516 can determine how to maneuver or operate the AV 502 safely and efficiently in its environment. For example, the planning stack 516 can receive the location, speed, and direction of the AV 502, geospatial data, data regarding objects sharing the road with the AV 502 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 502 from one point to another. The planning stack 516 can determine multiple sets of one or more mechanical operations that the AV 502 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 516 can select from multiple backup plans to carry out. For example, while preparing to change lanes to turn right at an intersection, another vehicle may aggressively cut into the destination lane, making the lane change unsafe. The planning stack 516 could have already determined an alternative plan for such an event, and upon its occurrence, help to direct the AV 502 to go around the block instead of blocking a current lane while waiting for art opening to change lanes.

The control stack 518 can manage the operation of the vehicle propulsion system 530, the braking system 532, the steering system 534, the safety system 536, and the cabin system 538. The control stack 518 can receive sensor signals from the sensor systems 504-508 as well as communicate with other stacks or components of the local computing device 510 or a remote system (e.g., the data center 550) to effectuate operation of the AV 502. For example, the control stack 518 can implement the final path or actions from the multiple paths or actions provided by the planning stack 516. This can involve turning the routes and decisions from the planning stack 516 into commands for the actuators that control the AV's steering, throttle, brake, and drive unit.

The communication stack 520 can transmit and receive signals between the various stacks and other components of the AV 502 and between the AV 502, the data center 550, the client computing device 570, and other remote systems. The communication stack 520 can enable the local computing device 510 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 520 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 522 can store HD maps and related data of the streets upon which the AV 502 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal U-turn lanes; permissive or protected only right turn lanes; etc.). The traffic controls lane can include geospatial information of traffic signal lights, traffic signs, and other road objects and related attributes.

The AV operational database 524 can store raw AV data generated by the sensor systems 504-508 and other components of the AV 502 and/or data received by the AV 502 from remote systems (e.g., the data center 550, the client computing device 570, etc.). In some embodiments, the raw AV data can include HD LIDAR point cloud data, image data, RADAR data, GPS data, and other sensor data that the data center 550 can use for creating or updating AV geospatial data as discussed further below with respect to FIG. 2 and elsewhere in the present disclosure.

The data center 550 can be a private cloud (e.g., an enterprise network, a co-location provider network, etc.), a public cloud (e.g., art Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 550 can include one or more computing devices remote to the local computing device 510 for managing a fleet of AVs and AV-related services. For example, in addition to managing the AV 502, the data center 550 may also support a ridesharing service, a delivery service, a remote/roadside assistance service, street services (e.g., street mapping, street patrol, street cleaning, street metering, parking reservation, etc.), and the like.

The data center 550 can send and receive various signals to and from the AV 502 and client computing device 570. These signals can include sensor data captured by the sensor systems 504-508, roadside assistance requests, software updates, ridesharing pick-up and drop-off instructions, and so forth. In this example, the data center 550 includes a data management platform 552, an Artificial Intelligence/Machine Learning (AI/ML) platform 554, a simulation platform 556, a remote assistance platform 558, a ridesharing platform 560, and map management system platform 562, among other systems.

Data management platform 552 can be a “big data” system capable of receiving and transmitting data at high velocities (e.g., near real-time or real-time), processing a large variety of data, and storing large volumes of data (e.g., terabytes, petabytes, or more of data). The varieties of data can include data having different structure (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 550 can access data stored by the data management platform 552 to provide their respective services.

The AI/ML platform 554 can provide the infrastructure for training and evaluating machine learning algorithms for operating the AV 502, the simulation platform 556, the remote assistance platform 558, the ridesharing platform 560, the map management system platform 562, and other platforms and systems. Using the AI/ML platform 554, data scientists can prepare data sets from the data management platform 552; select, design, and train machine learning models; evaluate, refine, and deploy the models; maintain, monitor, and retrain the models; and so on.

The simulation platform 556 can enable testing and validation of the algorithms, machine learning models, neural networks, and other development efforts for the AV 502, the remote assistance platform 558, the ridesharing platform 560, the map management system platform 562, and other platforms and systems. The simulation platform 556 can replicate a variety of driving environments and/or reproduce real-world scenarios from data captured by the AV 502, including rendering geospatial information and road infrastructure (e.g., streets, lanes, crosswalks, traffic lights, stop signs, etc.) obtained from the map management system platform 562; modeling the behavior of other vehicles, bicycles, pedestrians, and other dynamic elements; simulating inclement weather conditions, different traffic scenarios; and so on.

The remote assistance platform 558 cart generate and transmit instructions regarding the operation of the AV 502. For example, in response to an output of the AI/ML platform 554 or other system of the data center 550, the remote assistance platform 558 can prepare instructions for one or more stacks or other components of the AV 502.

The ridesharing platform 560 cart interact with a customer of a ridesharing service via a ridesharing application 572 executing on the client computing device 570. The client computing device 570 can be any type of computing system, including a server, desktop computer, laptop, tablet, smartphone, smart wearable device (e.g., smart watch, smart eyeglasses or other Head-Mounted Display (HMD), smart ear pods or other smart in-ear, on-ear, or over-ear device, etc.), gaming system, or other general purpose computing device for accessing the ridesharing application 572. The client computing device 570 can be a customer's mobile computing device or a computing device integrated with the AV 502 (e.g., the local computing device 510). The ridesharing platform 560 can receive requests to be picked up or dropped off from the ridesharing application 572 and dispatch the AV 502 for the trip.

Map management system platform 562 can provide a set of tools for the manipulation and management of geographic and spatial (geospatial) and related attribute data. The data management platform 552 can receive LIDAR point cloud data, image data (e.g., still image, video, etc.), RADAR data, GPS data, and other sensor data (e.g., raw data) from one or more AVs 502, UAVs, satellites, third-party mapping services, and other sources of geospatially referenced data. The raw data can be processed, and map management system platform 562 can render base representations (e.g., tiles (2D), bounding volumes (3D), etc.) of the AV geospatial data to enable users to view, query, label, edit, and otherwise interact with the data. Map management system platform 562 can manage workflows and tasks for operating on the AV geospatial data. Map management system platform 562 can control access to the AV geospatial data, including granting or limiting access to the AV geospatial data based on user-based, role-based, group-based, task-based, and other attribute-based access control mechanisms. Map management system platform 562 can provide version control for the AV geospatial data, such as to track specific changes that (human or machine) map editors have made to the data and to revert changes when necessary. Map management system platform 562 can administer release management of the AV geospatial data, including distributing suitable iterations of the data to different users, computing devices, AVs, and other consumers of HD maps. Map management system platform 562 can provide analytics regarding the AV geospatial data and related data, such as to generate insights relating to the throughput and quality of mapping tasks.

In some embodiments, the map viewing services of map management system platform 562 can be modularized and deployed as part of one or more of the platforms and systems of the data center 550. For example, the AI/ML platform 554 may incorporate the map viewing services for visualizing the effectiveness of various object detection or object classification models, the simulation platform 556 may incorporate the map viewing services for recreating and visualizing certain driving scenarios, the remote assistance platform 558 may incorporate the map viewing services for replaying traffic incidents to facilitate and coordinate aid, the ridesharing platform 560 may incorporate the map viewing services into the client application 572 to enable passengers to view the AV 502 in transit en route to a pick-up or drop-off location, and so on.

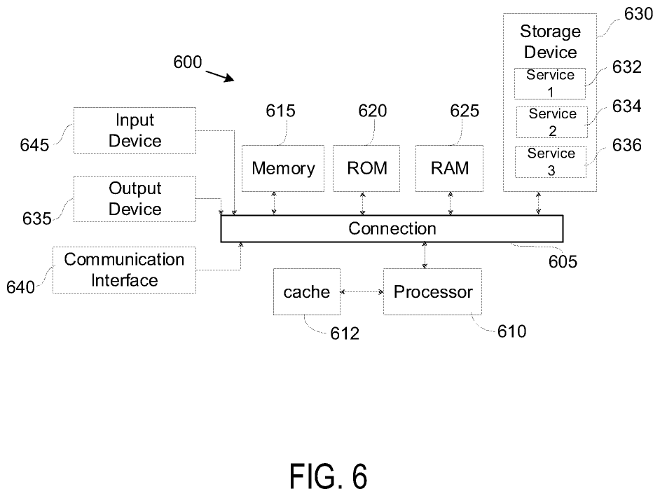

FIG. 6 illustrates art example processor-based system with which some aspects of the subject technology cart be implemented. For example, processor-based system 600 can be arty computing device making up internal computing system 610, remote computing system 650, a passenger device executing the rideshare app 670, internal computing device 630, or arty component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read-only memory (ROM) 620 and random access memory (RAM) 625 to processor 610. Computing system 600 can include a cache of high-speed memory 612 connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 cart be a non-volatile and/or non-transitory and/or computer-readable memory device and cart be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, arty other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

Storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, art Incremental Principal Component Analysis (PCA) algorithm, a Latent Dirichlet Allocation algorithm, and/or a Mini-batch K-means algorithm, etc.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A computer-implemented method comprising:
receiving image data;
receiving height map data, the height map data corresponding with a location of the image data;
projecting the height map data onto the image data to generate composite image data; and
training an object detection model based on the composite image data.

2. The computer-implemented method of claim 1, further comprising:
localizing one or more objects represented by the image data using the object detection model.

3. The computer-implemented method of claim 1, wherein the object detection model is a machine learning neural network.

4. The computer-implemented method of claim 1, wherein the height map data comprises Light Detection and Ranging (LiDAR) imaging data.

5. The computer-implemented method of claim 1, wherein the image data is obtained from a vehicle mounted camera.

6. The computer-implemented method of claim 1, further comprising:
receiving inertial measurement unit (IMU) data corresponding with the image data, wherein training the object detection model based on the composite image data further comprises the IMU data.

7. The computer-implemented method of claim 1, wherein the height map data includes depth information of the location.

8. A system comprising:
one or more processors; and
a computer-readable medium comprising instructions stored therein, which when executed by the processors, cause the processors to perform operations comprising:
receiving image data;
receiving height map data, the height map data corresponding with a location of the image data;
projecting the height map data onto the image data to generate composite image data; and
training an object detection model based on the composite image data.

9. The system of claim 8, wherein the processors are further configured to perform operations comprising:
localizing one or more objects represented by the image data using the object detection model.

10. The system of claim 8, wherein the object detection model is a machine learning neural network.

11. The system of claim 8, wherein the height map data comprises Light Detection and Ranging (LiDAR) imaging data.

12. The system of claim 8, wherein the image data is obtained from a vehicle mounted camera.

13. The system of claim 8, wherein the processors are further configured to perform operations comprising:
receiving inertial measurement unit (IMU) data corresponding with the image data, wherein training the object detection model based on the composite image data further comprises the IMU data.

14. The system of claim 8, wherein the height map data includes depth information of the location.

15. A non-transitory computer-readable storage medium comprising instructions stored therein, which when executed by one or more processors, cause the processors to perform operations comprising:
receiving image data;
receiving height map data, the height map data corresponding with a location of the image data;
projecting the height map data onto the image data to generate composite image data; and
training an object detection model based on the composite image data.

16. The non-transitory computer-readable storage medium of claim 15, wherein the processors are further configured to perform operations comprising:
localizing one or more objects represented by the image data using the object detection model.

17. The non-transitory computer-readable storage medium of claim 15, wherein the object detection model is a machine learning neural network.

18. The non-transitory computer-readable storage medium of claim 15, wherein the height map data comprises Light Detection and Ranging (LiDAR) imaging data.

19. The non-transitory computer-readable storage medium of claim 15, wherein the image data is obtained from a vehicle mounted camera.

20. The non-transitory computer-readable storage medium of claim 15, wherein the processors are further configured to perform operations comprising:
receiving inertial measurement unit (IMU) data corresponding with the image data, wherein training the object detection model based on the composite image data further comprises the IMU data.
